(19) United States
(12) Patent Application Publication
(10) Pub. No.: US 2013/0161167 A1
(43) Pub. Date: Jun. 27, 2013

(54) Switching Device with Auto-Correction of Switching Member

(71) Applicant: Colin Roberts, Naughton (CA)

(72) Inventor: Colin Roberts, Naughton (CA)

(21) Appl. No.: 13/712,137

(22) Filed: Dec. 12, 2012

Related U.S. Application Data
(60) Provisional application No. 61/630,984, filed on Dec. 23, 2011.

(51) Int. Cl. H01H 3/02

(52) U.S. Cl. CPC H01H 3/02
USPC 200/331

(57) ABSTRACT

Switching devices for controlling a load from multiple locations each monitor the position of the device's switch member, and generate signals in response to a change of the member from the ‘on’ position to the ‘off’ position, and vice versa. Upon detecting such a change, an ‘on’ or ‘off’ signal is sent to each other switching device, which automatically updates the position of its switching member to match that which was manually actuated by the user. A load connected to at least one of the switching devices is accordingly switched between an energized and non-energized state by making or breaking continuity in the load circuit at that switching device. By automatically updating the switching member positions among all the devices, a user can visually make an accurate determination of the load circuit status at any given time based on the current position of any switching member among the devices.

### CROSS REFERENCE TO RELATED APPLICATIONS

This application claims benefit under 35 U.S.C. 119(e) of U.S. Provisional Patent Application Ser. No. 61/630,984, filed Dec. 23, 2011, the entirety of which is incorporated herein by reference.

### FIELD OF INVENTION

The present invention pertains to switching devices for control of electrical circuits from multiple locations, and more particularly it pertains to a switching device that has actuators therein for correcting its switching member position to accurately reflect the current status of the controlled load at any given time.

### BACKGROUND OF THE INVENTION

The prescribed rule of installation for a toggle or rocker type single-pole light switch requires that the toggle/rocker lever is in its upper position when the light is ‘on’, and its lower position when the light is ‘off’. When the light is ‘off’ and the lever is up, one knows that the light bulb is burnt and should be replaced.

In a three-way or a four-way switch circuit, however, the prescribed convention does not apply. One switch has its lever up, the other switch has its lever down, or both levers are either up or down when the light is ‘on’ or ‘off’. Therefore, the use of a three-way or four-way switch always includes a moment of ambiguity for the operator. One has to flip the switch both up and down to find out whether the light bulb is still good or not. When the switches and the light socket are located in two separate rooms or on two separate floors, the inconvenience is somewhat greater. One is required to flip the switch and open a door or look up or down a stairway, to a basement for example, to positively confirm whether or not the light bulb is ‘on’ or ‘off’; and good or bad.

When a three-way or a four-way switch is installed in a bank of single-pole switches, its lever is often left in an odd position relative to the status of the light controlled by that switch. At first glance, that bank of switches may indicate to an untrained individual that one of the light bulbs is burnt out, or that one of the light fixtures has been left ‘on’ in the building. That is, a person who does not realize that the switch is a three-way or four-way switch may misinterpret the ‘up’ position of the switch as meaning that either the bulb(s) controlled by that switch have burnt out, or that there is a light still ‘on’ somewhere in the building that requires further action to turn it ‘off’.

Some attempt has been made in the prior art to provide more apparent visual feedback on the status of a load controlled by three-way switches

U.S. Pat. No. 3,238,343 of Carlson discloses an illuminated push-button three-way switch that incorporates a neon lamp that is energized when the load controlled by switch is in an active state. That is, when the load circuit between the load and the power supply is closed, the lamp is energized. Accordingly, an informed user will understand that an illuminated state of the switch is representative of an energized state of the load controlled by the switch. However, an uninformed person who has not been educated as to the meaning of the switch illumination will not be any better off than with a conventional three-way or four-way switch lacking such an illumination indicator reflecting the status of the load circuit.

Other references concerning circuits for load control from multiple locations in a manner similar to conventional three-way or four-way switching solutions include U.S. Pat. Nos. 5,340,954 and 7,656,308, where a ‘master’ switch operates the load and another slave or remote switch wirelessly transmits ‘on’ and ‘off’ signals to the master switch based on manipulation of the slave or remote switch.

Other remote control switching solutions in the prior art includes U.S. Pat. No. 7,671,711 which teaches a remote-controlled actuator linked to the handle of a circuit breaker for control thereof from a remote location.

None of the forgoing prior art teaches or suggests a solution in which control of a load from multiple locations using manually operated switching switches is provided, while using the physical position of the manual switching member of each switching device to accurately convey the status of the load circuit, whereby failure of the load to become energized when the switching members are in the ‘on’ position can be used to deduce a failure somewhere in the circuit, for example the burning out of a light bulb or the tripping of a circuit breaker.

The applicant has developed a unique solution addressing the forgoing shortcomings of the prior art by creating switching devices that provide control of the load from multiple locations while using a manual position change of one switching member to auto-correct the switching member positions of each other device so that the current position of each switching member accurately reflects the current state of the load circuit.

### SUMMARY OF THE INVENTION

According to one aspect of the invention, there is provided a switching device for use with another one or more of said switching device to control a load from multiple locations, said switching device comprising:
a switching member movable between an ‘on’ position reflective of an ‘on’ status of the load and an ‘off’ position reflective of an ‘off’ status of the load,
an operating module arranged to transmit and receive signals to and from said another one or more of said switching devices, and
an actuation mechanism operable by said operating module to move said switching member from the ‘off’ position to the ‘on’ position in response to an ‘on’ signal received by said operating module, and move said switching member from the ‘on’ position to the ‘off’ position in response to an ‘off’ signal received by said operating module.

The switching member preferably comprises a toggle or rocker lever.

The actuation mechanism may comprise a single actuator, or a pair of actuators each arranged to move the switching member into a respective one of said positions.

The actuation mechanism may comprise at least one electromagnet arranged to move the switching member from one of said positions to the other.

The actuation mechanism may comprise a pair of electromagnets each arranged to move the switching member into a respective one of said positions, with the operating module arranged to momentarily energize each electromagnet under receipt of a respective signal.

Alternatively, the actuation mechanism may comprise at least one shape memory alloy actuator arranged to move the switching member from one of said positions to the other.

A position monitoring mechanism operable to determine a positional status of the switching member may comprise at least one momentary switch operable to determine the positional status of the switching member.

The at least one momentary switch may comprise a momentary ‘on’ switch arranged for actuation by movement of the switching member into the ‘on’ position, and a momentary ‘off’ switch arranged for actuation by movement of the switching member into the ‘off’ position.

Alternatively, the position monitoring mechanism may comprise at least one position sensor operable to determine the positional status of the switching member.

The at least one position sensor may comprise a hall effect sensor.

The at least one position sensor may comprise a reed switch

Preferably the switching device includes a line terminal, a load terminal, and a switch arranged therebetween to conductively connect said terminals when the switching member is moved to the ‘on’ position.

Preferably the switching device includes a signal terminal for connection of a communication circuit thereto for communication of the operating module with said another one or more of said switching device.

According to a second aspect of the invention, there is provided an electrical circuit having at least two switching devices and a load connected to at least one of said switching devices for control of said load from multiple locations, wherein each of said switching devices comprises a switching member and an actuation mechanism operable to move said switching member between an ‘on’ position reflective of an ‘on’ status of the load and an ‘off’ position reflective of an ‘off’ status of the load, and an operating module arranged to move said switching member of said switching device from the ‘off’ position to the ‘on’ position in response to an ‘on’ signal received from any other of said switching devices, and move said switching member of said switching device from the ‘on’ position to the ‘off’ position in response to an ‘off’ signal received from said any other of said switching devices.

Preferably the switching devices are all identical to one another.

According to a third aspect of the invention there is provided a method of automatically indicating a powered or unpowered status of a load in a circuit at each of two or more switching devices that control said load from multiple locations using respective switching members of said switching devices, the method comprising the steps of:
(a) in response to manual movement of the respective switching member of a first one of said switching devices between an ‘off’ position reflective of an ‘off’ state of the load and an ‘on’ position reflective of an ‘on’ state of the load, transmitting a signal from said one of said switching devices to each other one of said switching devices; and
(b) in response to receipt of the signal at said each other one of said switching devices, automatically moving the switching member of said each other one of said switching devices to the same position into which the switching member of the first one of said switching devices was manually moved in step (a).

In one instance, the first one of said switching devices is a primary switching device having a load terminal wired to the load, and step (a) comprises changing an open or closed status of a switch of said primary switching device between said load terminal and a line terminal of said primary switching device.

In another instance, step (b) comprises receiving said signal at a primary switching device having a load terminal wired to the load, and in response to receiving the signal at the primary switching device, automatically changing an open or closed status of a switch of said primary switching device between said load terminal and a line terminal of said primary switching device.

In the switching devices according to the present invention, there is provided an electronic circuit and one or more actuators inside the device housing to move the switching member to a true-state position reflective of an actual state of the load circuit, regardless of the switching lever's last movement. As a result, when the light or other load is turned ‘on’ by one of the switching devices in the same circuit, the switching member of each other switching device is reset to the ‘on’ position. When the light is turned ‘off’ by one of the switching devices, the switching members on all the devices reset to the ‘off’ position.

Accordingly, in the case of using a conventional toggle or rocker switch position standard for control of a light wired to multiple switching devices of the present invention, the toggles/rockers of all the switching devices will be in their ‘up’ positions when the load circuit is closed to energize the load, and all the toggles/rockers will be in their ‘down’ positions when the load circuit is opened to de-energize the load.

In the preferred embodiment, the toggle/rocker operates two momentary contact switches of the switching device, which in turn operate an electronic controller of the switching device. The electronic controller sends a communication signal to the other switching devices in the circuit. A pair of electromagnets mounted under the toggle/rocker of each switching device are preferably used to pull the toggle/rocker to the correct position.

In another broad aspect of the present invention, the switching device has a switching member; actuators mounted therein for moving the switching member between an ‘on’ position and an ‘off’ position; a signal-transfer-and-receiving terminal thereon and an operating module mounted therein for operating one of the actuators upon receipt of a communication signal to the signal-transfer-and-receiving terminal.

In yet another aspect of the present invention, there is provided an electrical circuit having at least two switching devices and a load connected to these switching devices. Each of the switching devices has a rocker/toggle and actuators mounted therein for moving the rocker/toggle between an ‘on’ position and an ‘off’ position. The circuit includes a communication circuit connected to the switching devices for sending and receiving a communication signal to and from the switching devices. An operating module mounted in each of the switching devices operates the actuators upon receipt of the communication signal.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

Schematic drawings of the switching devices and circuit diagrams of the switching device actuators are shown in the drawings, in which:

FIG. 1 illustrates a side view of a rocker type switching device of the present invention with a see-through view inside the compartment under the rocker lever;

FIG. 2 illustrates a front view of the switching device;

FIG. 3 illustrates a front view of the switching device with the rocker lever removed;

FIG. 4 is a line-load circuit diagram incorporating several switching devices;

FIG. 5 is a circuit diagram of several operating modules mounted inside the switching devices in the circuit shown in FIG. 4;

FIG. 6 is a circuit diagram showing the components in the electronic controller mounted in each module illustrated in FIG. 5; and

FIG. 7 is a block diagram illustrating operation of the controller of each switching device.

### DETAILED DESCRIPTION OF THE PREFERRED EMBODIMENT

While this invention is susceptible of embodiment in many different forms, there is shown in the drawings and will be described in details herein one specific embodiment of a switching device with a position auto-correct system.

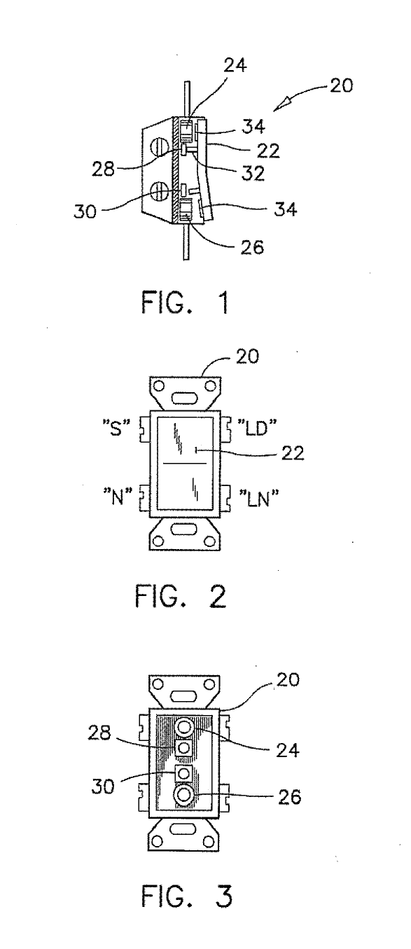

Referring firstly to FIGS. 1-3, the switching device 20 has a rocker lever or rocker panel 22, a pair of electromagnets 24, 26 under the rocker lever 22, and a pair of momentary contact switches 28, 30 under the rocker lever 22, next to the electromagnets 24, 26. The rocker lever 22 has a pair of prongs 32 aligning with the momentary contact switches 28, 30 to operate the momentary contact switches 28, 30 when the rocker lever is moved. The rocker lever 22 also has a pair of metal pieces 34 mounted on its rear surface, in alignment with the electromagnets 24, 26.

The upper momentary contact switch 28 and the upper electromagnet 24 are referred to as the ‘on’ switch and the ‘on’ electromagnet respectively. The lower momentary contact switch 30 and the lower electromagnet 26 are referred to as the ‘off’ switch and the ‘off’ electromagnet respectively.

The switching device 20 has four terminals which are identified as ‘LN’ for ‘line’; ‘LD’ for ‘load’, ‘N’ for ‘neutral’ and ‘S’ for ‘communication signal’. There is also preferably provided a ground terminal which is not represented on the drawing. A load-control switch ‘LS’ is wired between the ‘LN’ terminal and the ‘LD’ terminal, and makes and breaks continuity between these terminals under movement of the rocker lever into the ‘up/on’ and ‘off/down’ positions respectively. The manner in which the rocker lever opens and closes this connection between the terminals may be consistent with conventional single-pole toggle or rocker type light switches, and thus is not described or illustrated herein in detail.

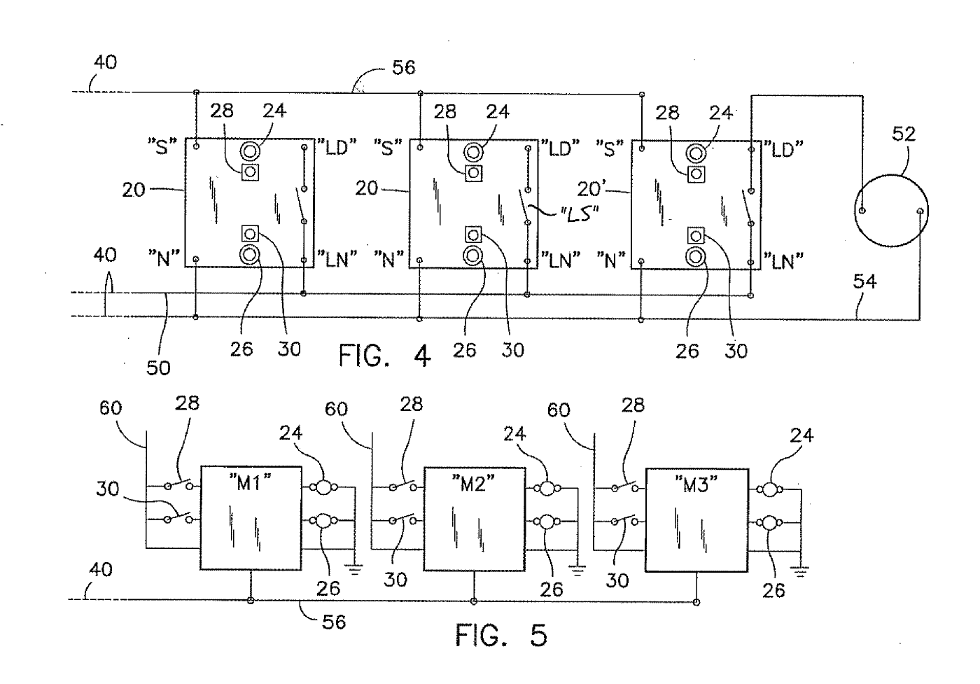

Referring to FIG. 4, the switching circuit will be explained. This circuit has three switching devices illustrated. The dashed lines 40 indicate that more than three switching devices can be installed in a same circuit, in a same way as those shown and described.

All the switching devices 20, 20′ have their line ‘LN’ terminals connected to a source of voltage 50. A neutral line 54 is connected to the neutral ‘N’ terminals of all switches. The ‘S’ terminals of all switches are connected to a common wire 56.

Only one of the switching devices 20′ has its load ‘LD’ terminal connected to a light socket 52, and is referred to as the ‘primary’ switching device. That switching device 20′ is thus connected in series with the light socket 52 just as a conventional single pole light switch would be for single-point control of the light. This way, operation of the rocker lever on the primary switching device 20′ directly controls the energization and de-energization of the light by opening and closing the load control switch ‘LD’.

All other switching devices 20 in the circuit, referred to as secondary switching devices, are used for the positions of their rocker levers 22, but carry no load at their ‘LD’ terminals. That is, the secondary switching devices do not directly open and close the load circuit, but rather use their rocker levers purely for the purposes of visually representing the open/closed state of the load circuit and indirectly changing the state of the load circuit via the primary switching device 20′.

The illustrated embodiment thus employs identical switching devices at the different load control positions in the circuit, with the particular wiring scheme among the devices determining which of the switching devices is a ‘primary switch’ whose rocker position directly controls the load.

In another embodiment, the load 52 can be connected to any of the switching devices 20. More than one load 52 can be connected to more than one switch 20. It will also be appreciated that when only one switch 20′ is used for switching the load 52, the load-switching components in the other switches 20 can be omitted. That is, this alternate embodiment may employ two distinct models of switching device, a ‘primary’ switch model according to the illustrated embodiment and a ‘secondary’ switch model that lacks an ‘LD’ terminal for connection to a load.

Each of the switching devices 20, 20′ has an electronic controller circuit therein. These electronic controller circuits are illustrated broadly in FIG. 5, and are referred to as modules ‘MI’, ‘M2’ and ‘M3’. Each module is mounted in the housing of a respective switching device 20 along with the respective electromagnets, positioning switches, and load switch. Power to each module is obtained through the supply line 60 from the line terminal ‘LN’ of each switch 20, 20′ for example.

The voltage at supply line 60 can be the same as power line 50 but it is preferably a voltage that is more appropriate for use in electronic control circuits, such as 12 volts DC for example. Therefore, each module ‘MI’, ‘M2’, ‘M3’ of the illustrated embodiment has its own step-down transformer and rectifier to supply low DC voltage to the electronic control circuit and the electromagnets 24, 26 in each module. In another embodiment, the electromagnets can be powered by line voltage.

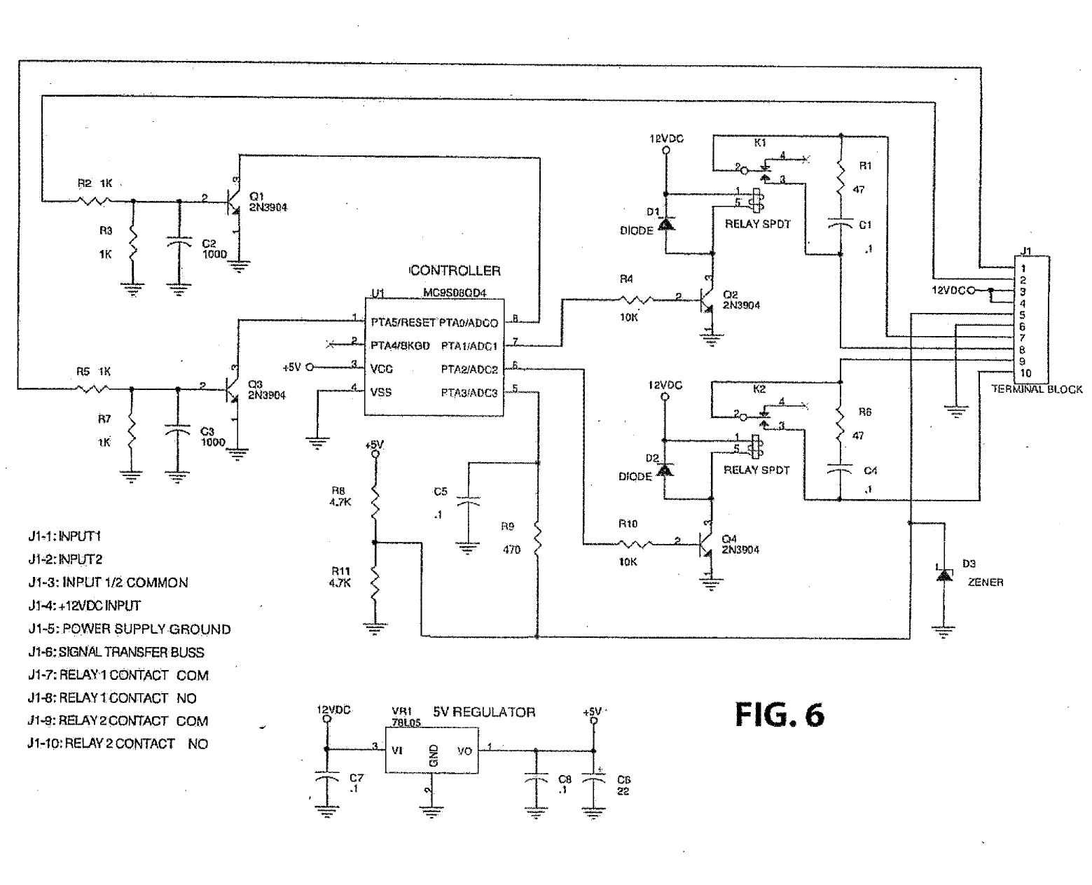

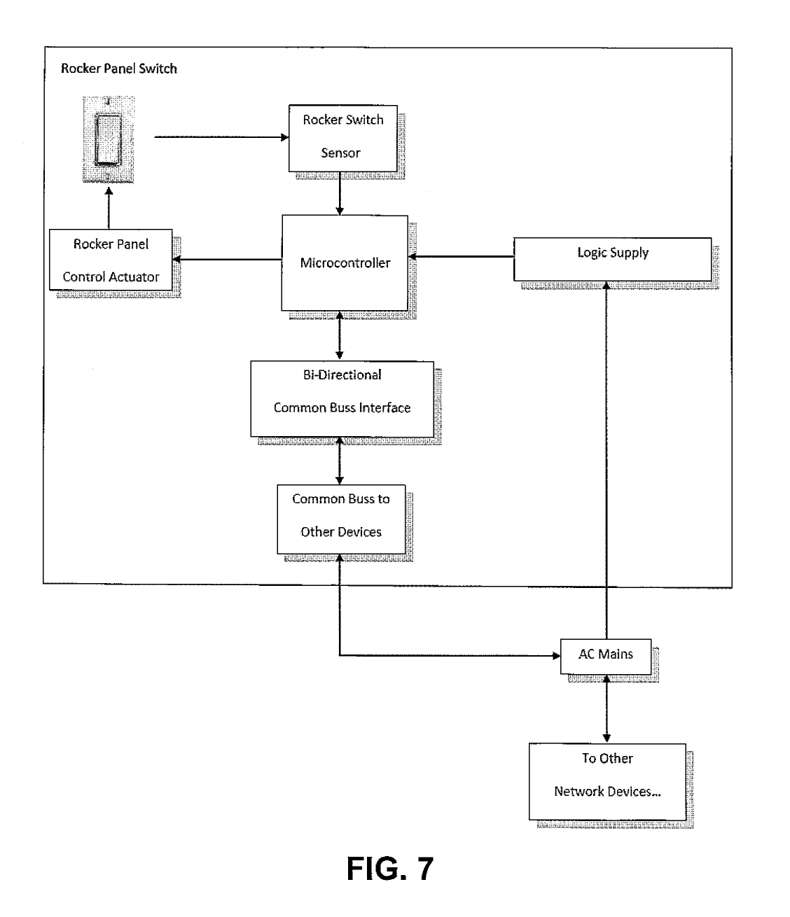

FIG. 6 is a schematic diagram of a microcontroller-based module employed in each switching device of the illustrated embodiment to perform the operations described herein below. It will be appreciated by those of skill in the art that alternate circuit designs suitable for accomplishing the same tasks may alternatively be employed.

Positions of the rocker levers 22 are communicated to all modules ‘MI’, ‘M2’ and ‘M3’ through and from the ‘S’ terminals and wire 56. When one of the ‘on’ momentary contact switches 28 is closed, all the ‘on’ electromagnets 24 are energized just long enough to pull all the rocker levers into the upper or ‘on’ position. When one of the ‘off’ momentary contact switches 30 is energized, all outputs to the ‘off’ electromagnets 26 are energized just long enough to pull all the rocker levers into the down or ‘off’ position. The duration of voltage impulse to the electromagnets 24, 26 may be limited to a fraction of a second, for example.

In other words, the control module in each switching device monitors for a change in the rocker position of that switching device based on a change in which one of the momentary contact switches is closed, and in response, generates an output signal reflective of the corresponding ‘on’ or ‘off’ position into which the rocker has been moved. This ‘on’ or ‘off’ signal is received by the control module of each switching device, which in response, momentarily energizes the one of the electromagnets of that switching device that matches the ‘on’ or ‘off’ signal received. Accordingly, based on a manual change of the rocker position of a given one switching device, the rocker position of each other switching device is automatically switched to match the new position of the manually manipulated rocker.

In another embodiment, it is also possible to isolate from the circuit the electromagnets inside the switch that has its rocker lever 22 pushed ‘on’ or ‘off’. That is, each control module may be configured to only energize one of its electromagnets in response to signals that originated from the one or more other switching devices.

While the illustrated embodiment uses a respective electromagnet for each of the two possible positions of each rocker, it is also possible to operate the rocker lever 22 of each switching device using a single electromagnet and a spring, as one may recognize. For example, a spring could bias the rocker into a predetermined one of the two possible positions, with a single electromagnet of the device being used to overcome the spring force and move the rocker into the other position upon detection of the appropriate signal. Such an embodiment may require that the electromagnet be kept in an energized state to hold the rocker lever against the spring force until such time as the opposite signal is received, reflecting that the rocker lever should be returned to its default, spring biased position.

In the illustrated embodiment, a single ‘signal’ wire 56 is used between the switching devices 20, 20′ in a same circuit. When one of the ‘on’ momentary contact switches 28 is closed, a 5 volt ‘on’ signal for example, is sent to all modules in the circuit. That 5 volt signal prompts all modules to energize their ‘up’ electromagnets 24. The signal wire 56 is used for both transmitting a signal and for receiving one.

When one of the ‘off’ momentary contact switches 30 is closed, a 0 volt ‘off’ signal for example, is sent to all modules in the circuit. That 0 volt signal prompts all modules to energize their ‘down’ electromagnets 26.

In the above preferred system, a floating voltage of 2.5 volt for example is used to indicate an idle state of each switch.

Although the secondary switches 20 in the illustrated example carry no load, a movement of any one of their rocker levers 22 causes a same movement in the rocker lever 22 of the primary switch 20′ in order to energize the load 52.

In summary of the illustrated embodiment, the system of the illustrated embodiment uniquely synchronizes the position of all rocker panel type electrical AC power control switching devices in a given closed AC powered circuit in which the switches provide control of the load from multiple positions. The system can thus provide load control functionally equivalent to a conventional ‘three-way circuit’, while adding the ability to use the physical position of each switch manipulator as a visual confirmation of the current open/closed status of the load circuit. A single wire common buss is used for bi-directional communication between other devices in the network. The device includes logic circuitry that senses the presence of user input from a rocker type electrical AC power switch. The device also monitors the status of the common buss in the network. When a device is user-activated by pressing the rocker panel, that device takes on the roll of a master device. The master device will communicate to all other slave devices by way of the common buss a rocker panel status update. The slave devices will then synchronize their rocker panels to match that of the master device. The rocker panel position is set by an electromagnet or solenoid that is controlled by the logic circuitry in each device. The device is powered from the AC line power.

Preferably the logic or control circuit is configured so that if power to the circuit is interrupted, this interruption is detected, and when power is restored, a responsive action is taken to reset all devices to a common setting, for example to move all the rocker panels into their ‘off’ positions.

It will be appreciated by those having knowledge of the electrical field that other voltage levels, light pulses, wireless transmissions and other signals can also be used to transmit a signal and a command between the modules ‘MI’, ‘M2’ ad ‘M3’. It will also be appreciated that the circuits shown in FIG. 6 are only one example of many other circuits capable of operating the preferred switching device in a manner as described above.

It will also be appreciated that switches employing switch manipulation members other than rocker or toggle type levers may be operable by a system similar to that described above. For example, a push-button switch or dial-type switch may similarly employ one or more internal actuators and control module to automatically change the button or dial position between ‘on’ and ‘off’ positions based on signals generated by and received from another switching device based on detection of a dial/button position change at that other switching device.

Just as switching members of the type not using ‘up/down’=‘on/off’ position conventions may be employed (push buttons, dials, etc.), so to may the present invention be used with toggle or rocker type switches that are not mounted and wired according to the up=on, down=off standard.

It will be appreciated that the drawings of the illustrated embodiment are based on a ‘rocker’ type manipulator, where two flat faces of a relatively broad lever face out from the switch housing at planes oriented slightly oblique to one another. The ‘up/on’ position of the rocker is achieved by pressing the upper one of the faces into a depressed position substantially flush with the front of the housing, and the ‘down/off’ position is achieved by pressing the lower face into the depressed position. The depressed face represents the current state of the switching device, and the other face angles obliquely outward from the front plane of the housing.

The up/down convention of the illustrated embodiment works equally as well with a toggle-style lever where a narrower lever presents a handle that projects outward from the face of the switch housing at all times, angling obliquely upward in the ‘on/up’ position, and angling obliquely downward in the ‘off/down’ position. In other words, the direction in which the distal end of the handle points defines the current state of the switching device.

While the illustrated embodiment has the momentary switches mounted at stationary positions on the housing of the device for actuation by prongs projecting rearward from the rocker lever to detect the switch position, the momentary switches may alternatively be mounted to the rocker lever for movement therewith and contact with respective elements mounted at fixed locations on the housing to actuate the momentary switches.

It will also be appreciated that actuators other than electromagnets can also be used for the purpose of automatically changing the position of the lever/manipulator, just as detection means other than momentary contact switches may be used to identify the current position of the lever/manipulator and monitor changes therein.

For example, solenoid actuators, small motors, or shape memory alloy actuators using a shape memory alloy such as Nitinol (Nickel Titanium alloy) may be used to effect the automatic movement of the lever. As mentioned above, some embodiments may use a single powered actuator in place of a pair of powered actuators to accomplish automated movement of the lever into the ‘on’ and ‘off’ positions. As an alternative to momentary contact switches, position sensors such as hall effect sensors or reed switches can be used to monitor changes in the lever position. A respective sensor may be used for each of the two possible switch positions, or a single sensor may be sufficient, for example using a lack of presence of the switch in one position as an indicator of the other position.

Lastly, the switching devices of the present invention can also be used to operate loads other than lighting fixtures, including various appliances and electrical devices and non-lighting fixtures. Therefore the above description and the drawings should not be construed as limiting the scope of the present invention.

What is claimed is:

1. A switching device for use with another one or more of said switching device to control a load from multiple locations, said switching device comprising:
a switching member movable between an ‘on’ position reflective of an ‘on’ status of the load and an ‘off’ position reflective of an ‘off’ status of the load,
an operating module arranged to transmit and receive signals to and from said another one or more of said switching device, and
an actuation mechanism operable by said operating module to move said switching member from the ‘off’ position to the ‘on’ position in response to an ‘on’ signal received by said operating module, and move said switching member from the ‘on’ position to the ‘off’ position in response to an ‘off’ signal received by said operating module.

2. The switching device of claim 1 wherein said switching member comprises a toggle or rocker lever.

3. The switching device of claim 1 wherein the actuation mechanism comprises a pair of actuators each arranged to move the switching member into a respective one of said positions.

4. The switching device of claim 1 wherein said actuation mechanism comprises at least one electromagnet arranged to move the switching member from one of said positions to the other.

5. The switching device of claim 4 wherein the actuation mechanism comprises a pair of electromagnets each arranged to move the switching member into a respective one of said positions.

6. The switching device of claim 5 wherein the operating module is arranged to momentarily energize each electromagnet under receipt of a respective signal.

7. The switching device of claim 1 wherein the actuation mechanism comprises at least one shape memory alloy actuator arranged to move the switching member from one of said positions to the other.

8. The switching device of claim 1 comprising a position monitoring mechanism operable to determine a positional status of the switching member.

9. The switching device of claim 8 wherein the position monitoring mechanism comprises at least one momentary switch operable to determine the positional status of the switching member.

10. The switching device of claim 8 wherein the position monitoring mechanism comprises a momentary ‘on’ switch arranged for actuation by movement of the switching member into the ‘on’ position, and a momentary ‘off’ switch arranged for actuation by movement of the switching member into the ‘off’ position.

11. The switching device of claim 8 wherein the position monitoring mechanism comprises at least one position sensor operable to determine the positional status of the switching member.

12. The switching device of claim 11 wherein the at least one position sensor comprises a hall effect sensor.

13. The switching device of claim 11 wherein the at least one position sensor comprises a reed switch.

14. The switching device of claim 1 comprising a line terminal, a load terminal, and a switch arranged therebetween to conductively connect said terminals when the switching member is moved to the ‘on’ position.

15. The switching device of claim 1 comprising a signal terminal for connection of a communication circuit thereto for communication of the operating module with said another one or more of said switching device.

16. An electrical circuit having at least two switching devices and a load connected to at least one of said switching devices for control of said load from multiple locations, wherein each of said switching devices comprises a switching member and an actuation mechanism operable to move said switching member between an ‘on’ position reflective of an ‘on’ status of the load and an ‘off’ position reflective of an ‘off’ status of the load, and an operating module arranged to move said switching member of said switching device from the ‘off’ position to the ‘on’ position in response to an ‘on’ signal received from any other of said switching devices, and move said switching member of said switching device from the ‘on’ position to the ‘off’ position in response to an ‘off’ signal received from said any other of said switching devices.

17. The electrical circuit of claim 16 wherein the switching devices are all identical to one another.

18. A method of automatically indicating a powered or unpowered status of a load in a circuit at each of two or more switching devices that control said load from multiple locations using respective switching members of said switching devices, the method comprising the steps of:
(a) in response to manual movement of the respective switching member of a first one of said switching devices between an ‘off’ position reflective of an ‘off’ state of the load and an ‘on’ position reflective of an ‘on’ state of the load, transmitting a signal from said one of said switching devices to each other one of said switching devices; and
(b) in response to receipt of the signal at said each other one of said switching devices, automatically moving the switching member of said each other one of said switching devices to the same position into which the switching member of the first one of said switching devices was manually moved in step (a).

19. The method of claim 18 wherein the first one of said switching devices is a master switching device having a load terminal wired to the load, and step (a) comprises changing an open or closed status of a switch of said master switching device between said load terminal and a line terminal of said master switching device.

20. The method of claim 18 wherein step (b) comprises receiving said signal at a master switching device having a load terminal wired to the load, and in response to receiving the signal at the master switching device, automatically changing an open or closed status of a switch of said master switching device between said load terminal and a line terminal of said master switching device.
